(19) United States
(12) Patent Application Publication
(10) Pub. No.: US 2016/0263778 A1
(43) Pub. Date: Sep. 15, 2016

(54) SEPARATION DEVICE AND SEPARATION METHOD

(71) Applicant: DAIKI CO., LTD., Tokyo (JP)

(72) Inventors: Hiroshi ITO, Tokyo (JP); Junji YOSHINAGA, Tokyo (JP)

(73) Assignee: DAIKI CO., LTD., Tokyo (JP)

(21) Appl. No.: 15/164,401

(22) Filed: May 25, 2016

Related U.S. Application Data
(63) Continuation of application No. PCT/JP2013/083141, filed on Dec. 10, 2013.

(51) Int. Cl. B29B 17/02; C08J 11/06

(52) U.S. Cl. CPC B29B 17/02; C08J 11/06; B29K 2023/12

(57) ABSTRACT

Provided are a separation device and a separation method with which plastic and aluminum can be separated. A separation device includes a separation unit. The separation unit includes a container and a scoop-up member. A processing target containing aluminum and one or more types of plastic is heated to a first temperature in the separation unit. The first temperature is a temperature that is less than the melting point of aluminum and is greater than or equal to the melting point of at least one type of plastic. The container accommodates the processing target heated to the first temperature. The scoop-up member has a hole portion allowing melted plastic to pass through, and separates aluminum and the melted plastic by scooping up the processing target accommodated in the container.

### CROSS REFERENCE TO RELATED APPLICATION

This is a Continuation of International Application No. PCT/JP2013/083141 filed Dec. 10, 2013. The contents of this application are hereby incorporated by reference in their entirety.

### TECHNICAL FIELD

The present invention relates to a separation device and a separation method.

### BACKGROUND ART

In recent years, the need to recycle resources has been increasing, and among resources, it is important to recycle plastic. With regard to recycling of plastic, various techniques have been proposed (Patent Literature 1, for example).

### CITATION LIST

### Patent Literature

[PLT 1] JP 2008-156532A

### SUMMARY OF INVENTION

### Technical Problem

Incidentally, among plastics, there are plastics to which aluminum adheres, such as an aluminized film. In order to recycle such plastic, it is necessary to separate the plastic and the aluminum.

### Solution to Problem

The present invention has been made in view of the above-described issues, and an object thereof is to provide a separation device and a separation method with which plastic and aluminum can be separated.

A separation device according to the present invention includes a first heating means for heating a processing target containing aluminum and one or more types of plastic to a first temperature, which is a temperature that is less than a melting point of the aluminum and is greater than or equal to a melting point of at least one type of the plastic, so as to melt the at least one type of the plastic, a first container that accommodates the processing target heated by the first heating means to the first temperature, and a first scoop-up member that has a hole portion allowing the plastic melted by the first heating means to pass through, and that separates the aluminum and the plastic melted by the first heating means by scooping up the processing target accommodated in the first container.

In the separation device, the processing target is heated by the first heating means to the first temperature. The first temperature is a temperature that is less than the melting point of aluminum and is greater than or equal to the melting point of at least one type of plastic. Accordingly, the at least one type of plastic, that is, plastic having a melting point that is less than or equal to the first temperature is melted. The processing target in which the at least one type of plastic is melted in this manner is scooped up by the first scoop-up member in a state in which the processing target is accommodated in the first container. At this time, since a hole portion is provided in the first scoop-up member, the melted plastic passes through this hole portion. Accordingly, aluminum is pulled up by the first scoop-up member, whereas the melted plastic remains in the first container. In this manner, aluminum and melted plastic are separated.

Also, a separation method according to the present invention includes a first heating step of heating a processing target containing aluminum and one or more types of plastic to a first temperature, which is a temperature that is less than a melting point of the aluminum and is greater than or equal to a melting point of at least one type of the plastic, so as to melt the at least one type of the plastic, and a first scoop-up step of scooping up, with a first scoop-up member having a hole portion allowing the plastic melted in the first heating step to pass through, the processing target accommodated in a first container that accommodates the processing target heated to the first temperature in the first heating step, so as to separate the aluminum and the plastic melted in the first heating step.

In the separation method, the processing target is heated to the first temperature in the first heating step. The first temperature is a temperature that is less than the melting point of aluminum and is greater than or equal to the melting point of at least one type of plastic. Accordingly, the at least one type of plastic, that is, plastic having a melting point that is less than or equal to the first temperature is melted. The processing target in which the at least one type of plastic is melted in this manner is scooped up by the first scoop-up member in the first scoop-up step in a state in which the processing target is accommodated in the first container. At this time, since a hole portion is provided in the first scoop-up member, the melted plastic passes through this hole portion. Accordingly, aluminum is pulled up by the first scoop-up member, whereas the melted plastic remains in the first container. In this manner, aluminum and melted plastic are separated.

### Advantageous Effects of Invention

According to the present invention, a separation device and a separation method with which plastic and aluminum can be separated are realized.

### BRIEF DESCRIPTION OF DRAWINGS

FIG. 1 is a configuration diagram showing an embodiment of a separation device according to the present invention.

FIG. 2 is a cross-sectional view showing a separation unit 20 in the separation device of FIG. 1.

FIG. 3 is a plan view showing the separation unit 20 in the separation device of FIG. 1.

FIG. 4 is a cross-sectional view showing a separation unit 40 in the separation device of FIG. 1.

FIG. 5 is a plan view showing the separation unit 40 in the separation device of FIG. 1.

FIG. 6 is a cross-sectional view for illustrating operations of the separation device of FIG. 1.

FIG. 7 is a cross-sectional view for illustrating operations of the separation device of FIG. 1.

FIG. 8 is a cross-sectional view for illustrating operations of the separation device of FIG. 1.

FIG. 9 is a cross-sectional view for illustrating operations of the separation device of FIG. 1.

### DESCRIPTION OF EMBODIMENTS

Hereinafter, an embodiment of the present invention will be described in detail with reference to drawings. Note that in the description of the drawings, like elements are denoted by like reference numerals and redundant descriptions are omitted.

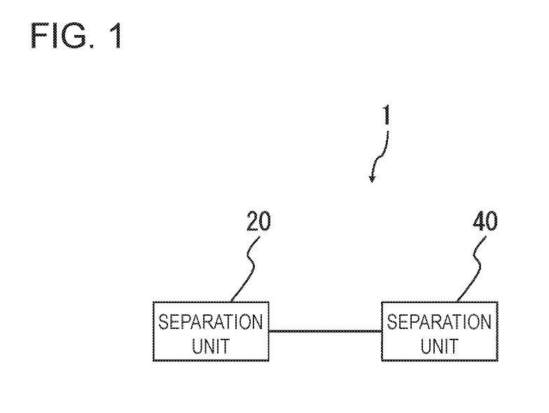

FIG. 1 is a configuration diagram showing an embodiment of a separation device according to the present invention. A separation device 1 is for separating aluminum and plastic by processing a processing target containing aluminum and one or more types of plastic, and extracting plastic from the processing target. The processing target is an aluminized film obtained by vapor-depositing aluminum on plastic, for example. In the present embodiment, the processing target contains three types of plastic, namely, polypropylene (PP), polyethylene (PE), and polyethylene terephthalate (PET). The separation device 1 includes a separation unit 20, and a separation unit 40.

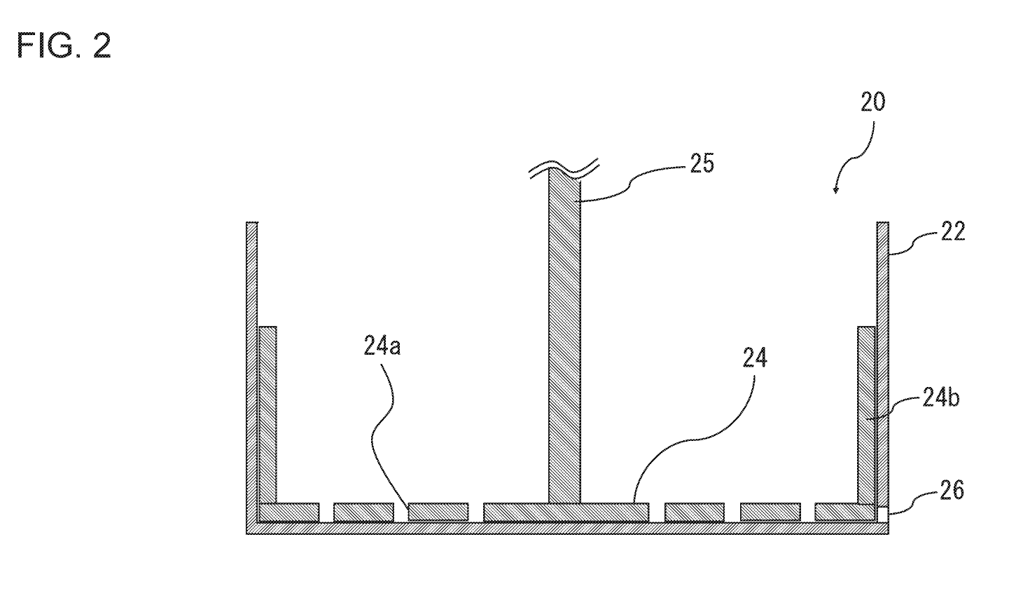

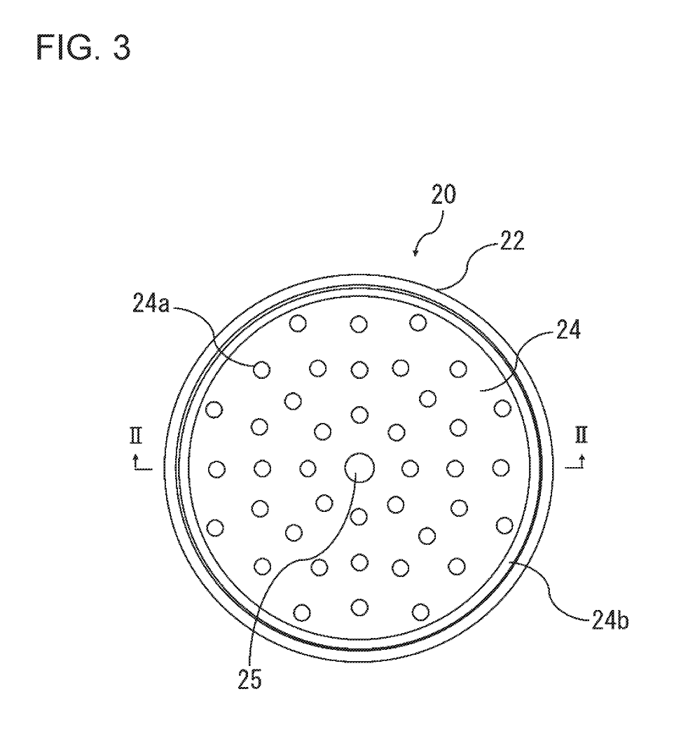

FIG. 2 is a cross-sectional view showing the separation unit 20. Also, FIG. 3 is a plan view showing the separation unit 20. FIG. 2 shows a cross-section taken along line II-II in FIG. 3. The separation unit 20 includes a container 22 (first container) that accommodates the processing target, and a scoop-up member 24 (first scoop-up member).

The container 22 includes a heating means (not shown), namely a heating means (first heating means) for heating the processing target accommodated in the container 22 to a first temperature. The first temperature is a temperature that is less than the melting point of aluminum (approximately 660° C.) and is greater than or equal to the melting point of at least one type of plastic. The first temperature is a temperature at which plastic to be separated and extracted does not burn. The first temperature of the present embodiment is 180° C. or greater and 220° C. or less. Melting points of PP, PE, and PET are respectively approximately 180° C., approximately 130° C., and approximately 270° C., and thus the first temperature is a temperature that is greater than or equal to the melting points of PP and PE, and that is less than the melting point of PET. Therefore, among PP, PE, and PET, and aluminum included in the processing target, only PP and PE are melted by being heated to the first temperature.

The container 22 has a heat insulation function, that is, a function of keeping the processing target accommodated therein at the first temperature. Note that the first temperature of the present embodiment is 180° C. or greater and 220° C. or less as described above, but the first temperature in the heating and the first temperature in the heat insulation are not necessarily identical as long as both of the first temperatures are within the above temperature range. An electric tank (electric furnace) can be used as the container 22, for example.

The scoop-up member 24 separates aluminum and melted plastic (PP and PE in the present embodiment) by scooping up the processing target accommodated in the container 22. Specifically, the scoop-up member 24 has hole portions 24a, and allows only the melted plastic to pass through the hole portions 24a when scooping up the processing target, thereby separating the plastic and aluminum. The hole portions 24a have a size and shape that allow melted plastic to pass through but do not allow unmelted plastic or aluminum to pass through. The shape of the hole portions 24a is circular in plan view in the present embodiment.

As shown in FIG. 3, the container 22 and the scoop-up member 24 are circular in plan view in the present embodiment. In other words, the container 22 is a container having a cylindrical side surface. Also, the scoop-up member 24 is composed of a disk-shaped bottom portion and a cylindrical side wall portion 24b. The side wall portion 24b has a function of preventing the processing target which has been scooped up from dropping from the rim of the scoop-up member 24. The outer diameter of the scoop-up member 24 is substantially equal to the inner diameter of the container 22. The scoop-up member 24 is provided slidably along the inner circumferential surface of the container 22. A shaft portion 25 is attached to the central portion of the scoop-up member 24. By applying upward force to the shaft portion 25, the processing target in the container 22 can be scooped up by the scoop-up member 24.

A discharging outlet 26 (first discharging outlet) is provided to penetrate the side surface of the container 22. The discharging outlet 26 is for discharging plastic that has been separated from aluminum, that is, for discharging melted plastic to the outside of the container 22. The discharging outlet 26 is provided so as to be opened and closed. The discharging outlet 26 is closed, except for when discharging melted plastic.

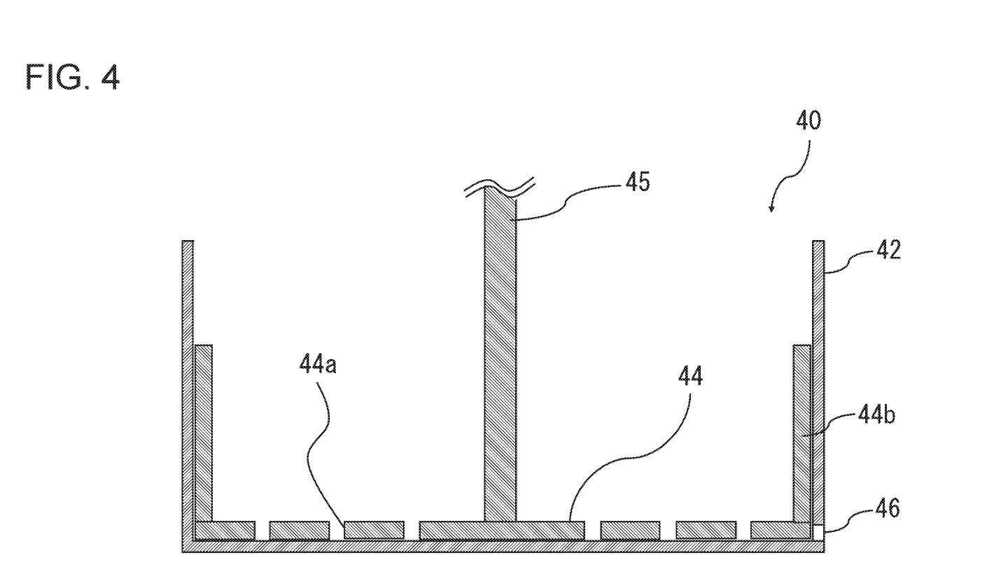

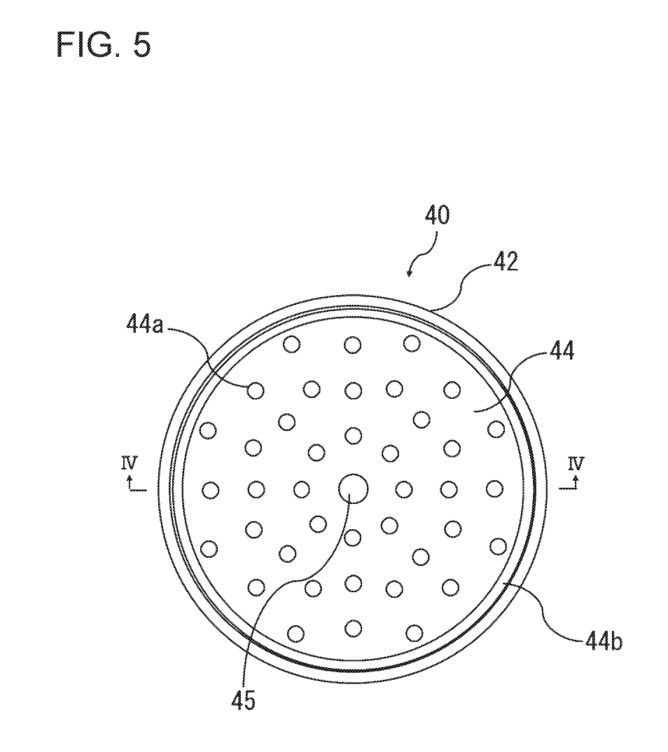

FIG. 4 is a cross-sectional view showing the separation unit 40. Also, FIG. 5 is a plan view showing the separation unit 40. FIG. 4 shows a cross-section taken along line IV-IV in FIG. 5. The separation unit 40 includes a container 42 (second container) that accommodates the processing target from which melted plastic has been separated in the container 22, and a scoop-up member 44 (second scoop-up member).

The container 42 includes a heating means (not shown), namely a heating means (second heating means) for heating the processing target accommodated in the container 42 to a second temperature. The second temperature is a temperature that is less than the melting point of aluminum (approximately 660° C.) and is greater than or equal to the melting point of at least one type of plastic that has not been melted in the container 22. In the present embodiment, only PET has not been melted in the container 22, and thus the second temperature is greater than or equal to the melting point of PET (approximately 270° C.). The second temperature is a temperature at which plastic to be separated and extracted does not burn. The second temperature of the present embodiment is 270° C. or greater and 310° C. or less. Therefore, among the PET and aluminum included in the processing target, only the PET is melted by being heated to the second temperature.

The container 42 has a heat insulation function, that is, a function of keeping the processing target accommodated therein at the second temperature. Note that the second temperature of the present embodiment is 270° C. or greater and 310° C. or less as described above, but the second temperature in the heating and the second temperature in the heat insulation are not necessarily identical as long as both of the second temperatures are within the above temperature range. An electric tank (electric furnace) can be used as the container 42, for example.

The scoop-up member 44 separates aluminum and melted plastic (PET in the present embodiment) by scooping up the processing target accommodated in the container 42. Specifically, the scoop-up member 44 has hole portions 44a, and allows only the melted plastic to pass through the hole portions 44a when scooping up the processing target, thereby separating the plastic and aluminum. The hole portions 44a have a size and shape that allow melted plastic to pass through but do not allow unmelted plastic or aluminum to pass through. The shape of the hole portions 44a is circular in plan view in the present embodiment.

As shown in FIG. 5, the container 42 and the scoop-up member 44 are circular in plan view in the present embodiment. In other words, the container 42 is a container having a cylindrical side surface. Also, the scoop-up member 44 is composed of a disk-shaped bottom portion and a cylindrical side wall portion 44b. The side wall portion 44b has a function of preventing the processing target which has been scooped up from dropping from the rim of the scoop-up member 44. The outer diameter of the scoop-up member 44 is substantially equal to the inner diameter of the container 42. The scoop-up member 44 is provided slidably along the inner circumferential surface of the container 42. A shaft portion 45 is attached to the central portion of the scoop-up member 44. By applying upward force to the shaft portion 45, the processing target in the container 42 can be scooped up by the scoop-up member 44. Note that the container 42 and the scoop-up member 44 are smaller than the above-described container 22 and the scoop-up member 24.

A discharging outlet 46 (second discharging outlet) is provided to penetrate the side surface of the container 42. The discharging outlet 46 is for discharging plastic that has been separated from aluminum, that is, for discharging melted plastic to the outside of the container 42. The discharging outlet 46 is provided so as to be opened and closed. The discharging outlet 46 is closed, except for when discharging melted plastic.

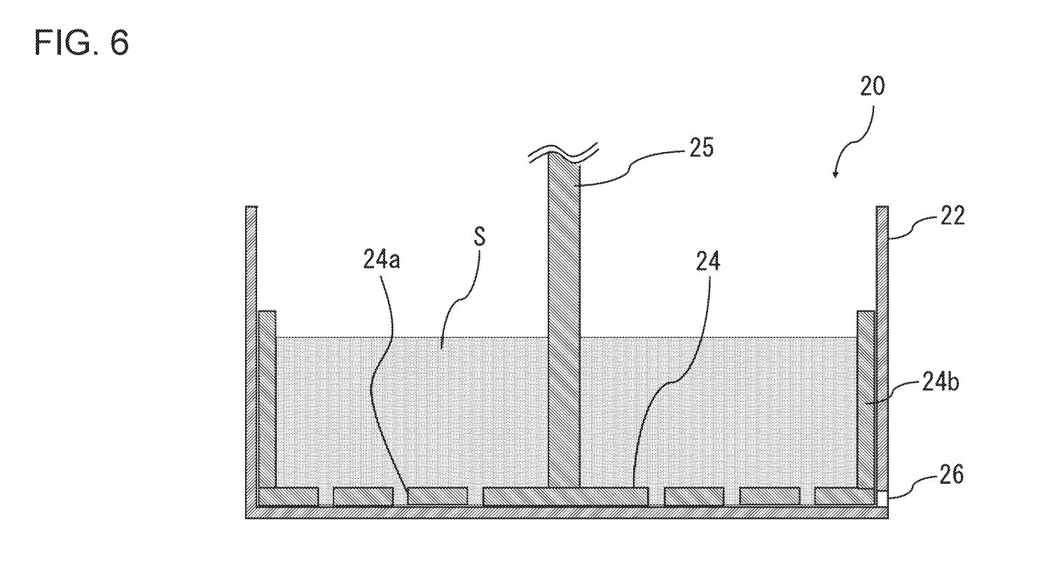

Next, the operations of the separation device 1 will be described as an embodiment of the separation method according to the present invention, with reference to FIGS. 6 to 9. First, as shown in FIG. 6, the processing target S is accommodated on the scoop-up member 24 in the container 22. The processing target S in that state is heated by the first heating means to the first temperature so as to melt PP and PE (a first heating step).

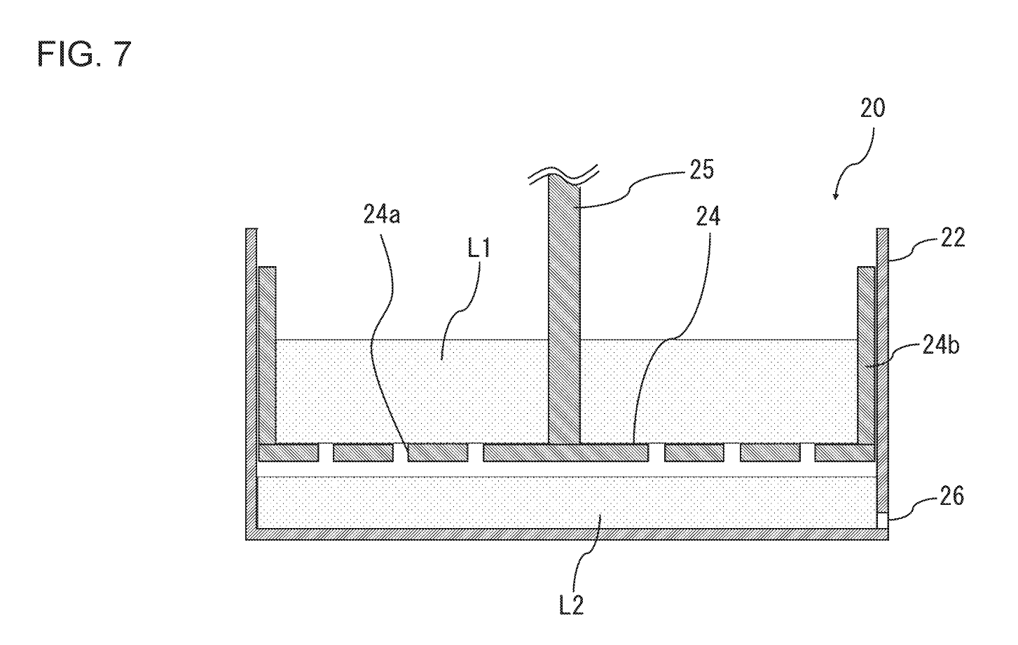

Next, as shown in FIG. 7, the processing target kept at the first temperature is scooped up by the scoop-up member 24. At this time, the melted PP and PE pass through the hole portions 24a of the scoop-up member 24, and drop to the bottom surface of the container 22. Accordingly, aluminum and PET are pulled up by the scoop-up member 24, whereas PP and PE remain in the container 22. Thus, the processing target is separated into a layer L1 constituted mainly by aluminum and PET and a layer L2 constituted mainly by PP and PE. In this manner, aluminum (and PET, which is unmelted plastic) is separated from PP and PE, which are melted plastic (a first scoop-up step).

Thereafter, by opening the discharging outlet 26, PP and PE separated from aluminum are discharged to the outside of the container 22 (first discharging step). Also, the aluminum and PET pulled up by the scoop-up member 24 are transferred to the container 42 of the separation unit 40. At this time, moisture may be removed from the aluminum and PET by means of dehydration through centrifugation or drying with warm air or the like, as needed.

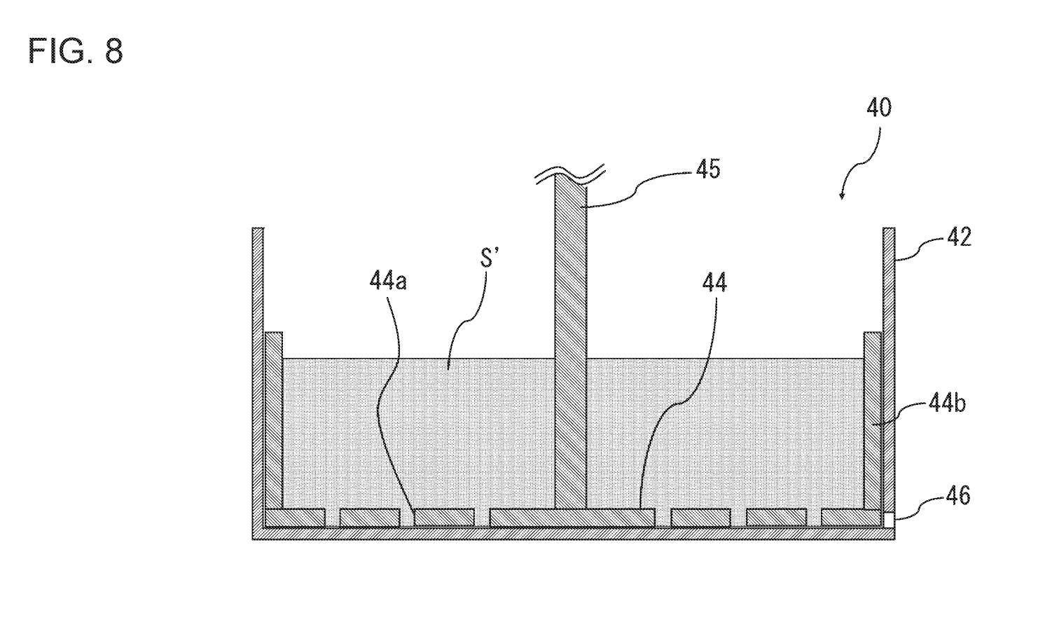

Subsequently, as shown in FIG. 8, the processing target S′ from which PP and PE have been separated is accommodated on the scoop-up member 44 in the container 42. The processing target S′ in that state is heated by the second heating means to the second temperature so as to melt PET (a second heating step).

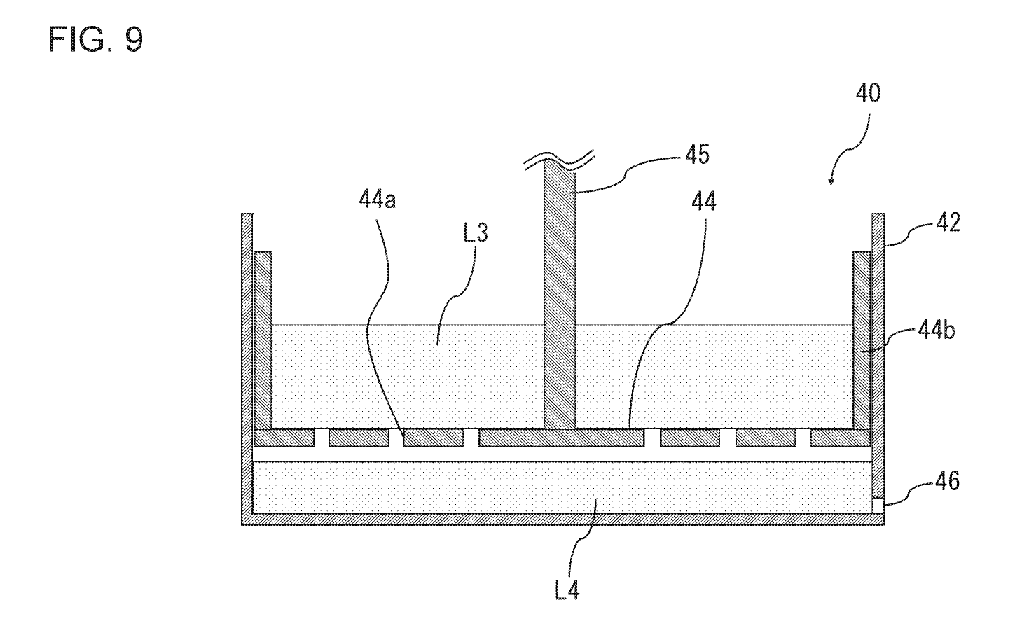

Next, as shown in FIG. 9, the processing target kept at the second temperature is scooped up by the scoop-up member 44. At this time, the melted PET (and PP and PE which have not been separated in the separation unit 20) passes through the hole portions 44a of the scoop-up member 44, and drops to the bottom surface of the container 42. Accordingly, aluminum is pulled up by the scoop-up member 44, whereas PET remains in the container 42. Thus, the processing target is separated into a layer L3 constituted mainly by aluminum and a layer L4 constituted mainly by PET. In this manner, aluminum is separated from PET, which is melted plastic (a second scoop-up step).

Thereafter, by opening the discharging outlet 46, PET separated from aluminum is discharged to the outside of the container 42 (second discharging step).

Effects of the present embodiment will be described. In the present embodiment, the processing target is heated to the first temperature in the separation unit 20. Accordingly, PP and PE, that is, plastic having a melting point that is less than or equal to the first temperature is melted. The processing target in which PP and PE are melted in this manner is scooped up by the scoop-up member 24 in a state in which the processing target is accommodated in the container 22. At this time, since the hole portions 24a are provided in the scoop-up member 24, the melted plastic (PP and PE) passes through the hole portions 24a. Accordingly, aluminum (and PET, which is unmelted plastic) is pulled up by the scoop-up member 24, whereas PP and PE remain in the container 22. In this manner, aluminum is separated from PP and PE.

Conventionally, it has been difficult to separate a highly-pure plastic from an aluminized film, but the separation technique according to the present embodiment can be used practically. The obtained PP and PE can be reused as a plastic material. Although PP and PE can be reused as a mixture, if necessary, PP and PE may be separated.

The scoop-up member 24 is provided slidably along the inner circumferential surface of the container 22. That is, the upper side and the lower side of the scoop-up member 24 are in communication with each other through only the hole portions 24a. Therefore, it is possible to prevent the unmelted plastic (PET) and aluminum from moving to the lower side of the scoop-up member 24.

The discharging outlet 26 is provided in the side surface of the container 22. Accordingly, the separated plastic (PP and PE) can be easily brought out from the container 22.

Also, not only the separation unit 20 but also the separation unit 40 is provided in the present embodiment. The processing target is heated to the second temperature in the separation unit 40. Accordingly, PET, that is, plastic having a melting point that is less than or equal to the second temperature is melted. The processing target in which PET is melted in this manner is scooped up by the scoop-up member 44 in a state in which the processing target is accommodated in the container 42, At this time, since the hole portions 44a are provided in the scoop-up member 44, the melted plastic (PET) passes through these hole portions 44a. Accordingly, aluminum is pulled up by the scoop-up member 44, whereas PET remains in the container 42. In this manner, aluminum and PET are separated. The obtained PET can be reused as a plastic material. Also, aluminum separated from plastic can be reused.

The scoop-up member 44 is provided slidably along the inner circumferential surface of the container 42. That is, the upper side and the lower side of the scoop-up member 44 are in communication with each other through only the hole portions 44a. Therefore, it is possible to prevent aluminum from moving to the lower side of the scoop-up member 44.

A discharging outlet 46 is provided in the side surface of the container 42. Accordingly, the separated plastic (PET) can be easily brought out from the container 42.

The separation device and the separation method according to the present invention are not limited to the above-described embodiment, and various modifications can be made thereto. For example, a case where the processing target contains three types of plastic (PP, PE, and PET) has been described in the above-described embodiment. However, it is possible for the processing target to contain only one type of plastic. In such a case, the plastic can be separated by merely performing heating and separation one time each, and thus it is not necessary to provide the separation unit 40.

In general, the processing target may contain n types (n is an integer that is greater than or equal to 2) of plastic. In the case where the first temperature is set to a temperature that is greater than or equal to each melting point of m types (m is an integer that is greater than or equal to 1 and less than n) of plastic, and that is less than each melting point of (n−m) types of plastic, the m types of plastic are melted by the first heating means and are separated from aluminum by the scoop-up member 24. In this case, the second temperature is a temperature that is less than the melting point of the aluminum and that is greater than or equal to the melting point of at least one of the (n−m) types of plastic. Note that a case of n=3 and m=2 has been described as an example in the above-described embodiment.

In the above-described embodiment, a case in which separation of plastic is performed two times has been described. However, separation of plastic may be performed three times or more. For example, in the case where the processing target contains three types of plastic that need to be separated and extracted individually, it is sufficient to perform separation three times.

In the above-described embodiment, an example in which the first container (container 22) and the second container (container 42) are provided separately from each other has been described. However, the first container and the second container may be the same container. That is, one container may be used as the first container and the second container.

In the above-described embodiment, an example in which the first and second heating means are provided, respectively, in the container 22 and the container 42 has been described. However, these heating means may be provided independently from the container 22 and the container 42. A rotary furnace can be used as such heating means, for example.

In the above-described embodiment, hole portions 24a that are circular in plan view have been described as an example. However, the hole portions 24a may have another shape (rectangular shape in plan view, for example). Also, the hole portions 24a may be formed by making substantially the entirety or a portion of the bottom portion of the scoop-up member 24 a net-like shape. In other words, in this case, the meshes of the bottom portion of the scoop-up member 24 correspond to the hole portions 24a. The same applies to the hole portions 44a.

### LIST OF REFERENCE NUMERALS

1 Separation device
20 Separation unit
22 Container (first container)
24 Scoop-up member (first scoop-up member)
24a Hole portion
24b Side wall portion
25 Shaft portion
26 Discharging outlet (first discharging outlet)
40 Separation unit
42 Container (second container)
44 Scoop-up member (second scoop-up member)
44a Hole portion
44b Side wall portion
45 Shaft portion
46 Discharging outlet (second discharging outlet)

1. A separation device, comprising:
a first heating means for heating a processing target containing aluminum and one or more types of plastic to a first temperature, which is a temperature that is less than a melting point of the aluminum and is greater than or equal to a melting point of at least one type of the plastic, so as to melt the at least one type of the plastic;
a first container that accommodates the processing target heated by the first heating means to the first temperature; and
a first scoop-up member that has a hole portion allowing the plastic melted by the first heating means to pass through, and that separates the aluminum and the plastic melted by the first heating means by scooping up the processing target accommodated in the first container.

2. The separation device according to claim 1, wherein
the first scoop-up member is provided slidably along an inner circumferential surface of the first container.

3. The separation device according to claim 1, comprising
a first discharging outlet that is provided to penetrate a side surface of the first container, and discharges the plastic that has been melted by the first heating means and has been separated from the aluminum by the first scoop-up member, to an outside of the first container.

4. The separation device according to claim 1, wherein
the first heating means is provided to the first container, and
the processing target is heated by the first heating means to the first temperature in a state in which the processing target is accommodated in the first container.

5. The separation device according to claim 1, wherein
the processing target contains n types (n is an integer that is greater than or equal to 2) of the plastic,
the first temperature is a temperature that is greater than or equal to each melting point of m types (m is an integer that is greater than or equal to 1 and less than n) of the plastic, and that is less than each melting point of (n−m) types of the plastic, and
the m types of the plastic are melted by the first heating means, and are separated from the aluminum by the first scoop-up member.

6. The separation device according to claim 5, comprising:
a second heating means for heating the processing target, from which the m types of the plastic have been separated, to a second temperature, which is a temperature that is less than the melting point of the aluminum and is greater than or equal to the melting point of at least one type of the (n−m) types of the plastic, so as to melt the at least one type of the plastic;
a second container that accommodates the processing target heated by the second heating means to the second temperature; and
a second scoop-up member that has a hole portion allowing the plastic melted by the second heating means to pass through, and that separates the aluminum and the plastic melted by the second heating means by scooping up the processing target accommodated in the second container.

7. The separation device according to claim 6, wherein
the second scoop-up member is provided slidably along an inner circumferential surface of the second container.

8. The separation device according to claim 6, comprising
a second discharging outlet that is provided to penetrate a side surface of the second container, and discharges the plastic that has been melted by the second heating means and has been separated from the aluminum by the second scoop-up member, to an outside of the second container.

9. The separation device according to claim 6, wherein
the second heating means is provided to the second container, and
the processing target is heated by the second heating means to the second temperature in a state in which the processing target is accommodated in the second container.

10. The separation device according to claim 1, wherein
the processing target contains polypropylene, polyethylene, and polyethylene terephthalate as the plastic.

11. The separation device according to claim 1, wherein
the processing target is an aluminized film obtained by vapor-depositing the aluminum on the plastic.

12. A separation method, comprising:
a first heating step of heating a processing target containing aluminum and one or more types of plastic to a first temperature, which is a temperature that is less than a melting point of the aluminum and is greater than or equal to a melting point of at least one type of the plastic, so as to melt the at least one type of the plastic; and
a first scoop-up step of scooping up, with a first scoop-up member having a hole portion allowing the plastic melted in the first heating step to pass through, the processing target accommodated in a first container that accommodates the processing target heated to the first temperature in the first heating step, so as to separate the aluminum and the plastic melted in the first heating step.

13. The separation method according to claim 12, wherein
the first scoop-up member is provided slidably along an inner circumferential surface of the first container.

14. The separation method according to claim 12, comprising
a first discharging step of discharging the plastic that has been melted in the first heating step and has been separated from the aluminum in the first scoop-up step, through a first discharging outlet provided to penetrate a side surface of the first container, to an outside of the first container.

15. The separation method according to claim 12, wherein
the processing target contains n types (n is an integer that is greater than or equal to 2) of the plastic,
the first temperature is a temperature that is greater than or equal to each melting point of m types (m is an integer that is greater than or equal to 1 and less than n) of the plastic, and that is less than each melting point of (n−m) types of the plastic, and
the m types of the plastic are melted in the first heating step, and are separated from the aluminum in the first scoop-up step.

16. The separation method according to claim 15, comprising:
a second heating step of heating the processing target, from which the m types of the plastic have been separated, to a second temperature, which is a temperature that is less than the melting point of the aluminum and is greater than or equal to the melting point of at least one type of the (n−m) types of the plastic, so as to melt the at least one type of the plastic; and
a second scoop-up step of scooping up, with a second scoop-up member having a hole portion allowing the plastic melted in the second heating step to pass through, the processing target accommodated in a second container that accommodates the processing target heated to the second temperature in the second heating step, so as to separate the aluminum and the plastic melted in the second heating step.

17. The separation method according to claim 16, wherein
the second scoop-up member is provided slidably along an inner circumferential surface of the second container.

18. The separation method according to claim 16, comprising
a second discharging step of discharging the plastic that has been melted in the second heating step and has been separated from the aluminum in the second scoop-up step, through a second discharging outlet provided to penetrate a side surface of the second container, to an outside of the second container.

19. The separation method according to claim 12, wherein
the processing target contains polypropylene, polyethylene, and polyethylene terephthalate as the plastic.

20. The separation method according to claim 12, wherein
the processing target is an aluminized film obtained by vapor-depositing the aluminum on the plastic.
